(19) United States
(12) Patent Application Publication
(10) Pub. No.: US 2010/0160480 A1
(43) Pub. Date: Jun. 24, 2010

(54) PHOTOCURABLE INTERPENETRATING POLYMER NETWORKS

(75) Inventors: Richard F. Tomko, North Olmsted, OH (US); Revathi R. Tomko, North Olmsted, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/642,985

(22) Filed: Dec. 21, 2009

Related U.S. Application Data
(60) Provisional application No. 61/139,803, filed on Dec. 22, 2008.

(51) Int. Cl. C08F 2/46; C08L 75/04; C08L 67/00

(52) U.S. Cl. 522/174; 525/453; 525/418

(57) ABSTRACT

A resin composition comprising an interpenetrating polymer network comprising:
(a) 5 to 95 weight percent of a polyurethane prepolymer;
(b) 5 to 95 weight percent of a waterborne polymer component; and
(c) optionally, a chain extender or crosslinker;
   wherein either the polyurethane prepolymer has at least one functional group that is photopolymerizable or the waterborne polymer component has at least one functional group that is photopolymerizable; or wherein both the polyurethane prepolymer and waterborne polymer component have at least one functional group that is photopolymerizable.

This application claims the benefit of U.S. provisional patent application No. 61/139,803 filed on Dec. 22, 2008.

The present invention is directed to a novel composition of a photocurable interpenetrating polymer network and coating compositions comprising a photocurable interpenetrating polymer network. An interpenetrating polymer network is defined as a polymer system comprising two or more constituent polymer networks that are polymerized and/or crosslinked in the immediate presence of one another. In effect, such a polymeric system comprises two or more network polymers that interpenetrate each other to some extent and characterized as a three-dimensional polymer structure. A “partial interpenetrating network” or “semi-interpenetrating network” comprises at least two components; a polyurethane component and a waterborne polymer component, wherein the polyurethane component is at least partially prepared in the presence of the waterborne polymer component, and wherein one or both of said components can contain functional groups that allow it to cure or crosslink with itself or with the other component, upon application to the substrate.

### SUMMARY OF THE INVENTION

This invention is a resin composition comprising an interpenetrating polymer network comprising:
(a) 5 to 95 weight percent of a polyurethane prepolymer;
(b) 5 to 95 weight percent of a waterborne polymer component; and
(c) optionally, a chain extender or crosslinker;
   wherein either the polyurethane prepolymer has at least one functional group that is photopolymerizable or the waterborne polymer component has at least one functional group that is photopolymerizable, or both the polyurethane prepolymer and waterborne polymer component have at least one functional group that is photopolymerizable. The photopolymerizable group of the polyurethane prepolymer and/or waterborne polymer component can be a (meth)acrylate, olefinic carbon-carbon double bonds, allyloxy, α-methyl styrene, (meth)acrylamide, combinations of these, and the like.

The polyurethane prepolymer and/or the waterborne polymer component can contain functional groups that allow them to polymerize, chain extend or crosslink in situ with itself or with the other component upon addition of a chain extender or crosslinker.

While there are a number of different variations and embodiments to the present invention, central to the success of the invention is the preparation of two components, one or both of which contain a functional group that is photopolymerizable, and one or both components have an additional functional group capable of additional polymerization, chain extension or crosslinking in the presence of a chain extender or crosslinker.

In one embodiment, a methacrylated polyurethane is prepared as a prepolymer which is neutralized and dispersed into a latex polymer composition and is subsequently chain extended with a polyamine. In another embodiment, a methacrylated polyurethane is prepared as a prepolymer which is neutralized and dispersed into a methacrylated waterborne component or latex and is subsequently chain extended with a polyamine to form a photopolymerizable interpenetrating network. Additionally, the functionalized waterborne polymer component may contain functional groups such as amino, hydroxyl, mercapto, carbonyl (e.g., diacetone acrylamide (DAAM)), acetoacetoxy (e.g., acetoacetoxyethyl methacrylate (AAEM)), or epoxy, to react directly with the methacrylated polyurethane prepolymer in the presence of chain extender orcrosslinker. In a further embodiment, a methacrylated polyurethane is prepared as a prepolymer that contains additional functional groups such as acetoacetoxy, epoxy, carbonyl or maleic/fumaric that may react with a functionalized waterborne polymer component or a latex that contains an additional functional group that can react with both the functionalized waterborne component in the presence of a chain extender or crosslinker. In yet another embodiment is a (meth)acrylated latex dispersed into a polyurethane prepolymer and subsequently chain extended.

The polymer network produced by the process of the present invention contain interpenetrating networks of two or more polymers. The polymer network, and coatings containing the polymer network, produced by the present invention are photocurable and, due to any residual additional functionalities of the polyurethane and waterborne polymers, can also have crosslinking ability for dual cure mechanism. That is, the interpenetrating network resin may cure in UV or visible light in the presence of added photoinitiators, and an additional cure may be possible if the proper crosslinker is added to induce the functionality of the waterborne polymer component to crosslink after film formation, i.e. addition of adipic dihydrazide to a DAAM-functional IPN in which the DAAM is from the residual waterborne polymer component. Or, a dual cure in which metal driers and photoinitiators are added to the photocurable IPN in which the waterborne polymer component contains oxidative unsaturation.

Additionally, a photocurable IPN containing oxidative unsaturation may be cured without photoinitiators, if metal driers, commonly used to cure alkyds, are added. By way of example, compositions in which crosslinking by auto-oxidative groups such as fatty amines, fatty acids or drying oils, or derivatives thereof, can be used.

### DETAILED DESCRIPTION OF THE INVENTION

The compositions of this invention are polymer systems comprising a polyurethane component and a waterborne polymer component, wherein the polyurethane prepolymer has at least one functional group that is photopolymerizable or the waterborne polymer component has at least one functional group that is photopolymerizable, or both the polyurethane prepolymer and waterborne polymer component have at least one functional group that is photopolymerizable. A methacrylated polyurethane component and functionalized waterborne component can be coreacted to produce an interpenetrating polymer network that is highly integrated, photocurable in the presence of photoinitiators and may additionally cure through alternative crosslinking mechanisms such as, for example, by way of crosslinkers or chain extenders added to the formulated coating. Coating compositions containing the interpenetrating networks of the present invention exhibit superior film properties such as improved MEK resistance, film hardness, water and alkali resistance and flexibility.

In some embodiments, it can be appreciated that some polymers do not undergo crosslinking reactions nor covalent bonding with the photopolymerized polymer matrix, yet these polymers may still comprise polymer chains that are entangled within the photopolymerized polymer matrix. Such entangled matrices are generally referred to in the art as partial-interpenetrating polymer networks, partial-IPN's, or semi-IPNs. As used herein, “photopolymerizable” refers to functionality directly or indirectly pendant from a monomer, oligomer, and/or polymer backbone (as the case may be) that participates in curing reactions upon exposure to actinic radiation, especially in the presence of added photoinitiators. Such functionality generally includes a group(s) that can cure via a free radical mechanism. By actinic radiation is meant electromagnetic radiation, such as near infrared (NIR), visible light, UV radiation, X-rays or gamma radiation, especially UV radiation, and corpuscular radiation, such as electron beams, alpha radiation, beta radiation, proton beams or neutron beams, especially electron beams. Representative examples of such photopolymerizable groups suitable in the practice of the present invention include (meth)acrylate groups, olefinic carbon-carbon double bonds, allyloxy groups, α-methyl styrene groups, (meth)acrylamide groups, combinations of these, and the like. Free radical polymerizable groups are preferred. Of these, (meth)acryl moieties are suitable. The term “(meth)acrylate”, as used herein, encompasses acrylate and/or methacrylate.

As used herein, the term “monomer” means a relatively low molecular weight material (i.e., having a molecular weight less than about 500 g/mole) having one or more polymerizable groups. “Oligomer” means a relatively intermediate molecular weight (i.e., having a molecular weight of from about 500 up to about 10,000 g/mole) material having one or more polymerizable groups. “Polymer” means a relatively large molecular weight (i.e., about 10,000 g/mole or more) material that may or may not have available curing functionality. The term “molecular weight” as used throughout this specification means number average molecular weight unless expressly noted otherwise. As used herein, the term “resin” shall be used to refer collectively to oligomers and polymers.

The photopolymerizable precursor preferably includes one or more monomers, oligomers, and/or polymers with photopolymerizable functionality. Preferably, the precursor includes at least one such monomer. Subject to desired performance standards, any photopolymerizable monomer or combinations thereof may be incorporated into the photopolymerizable precursor. Accordingly, the present invention is not intended to be limited to specific kinds of photopolymerizable monomers in various aspects so long as any such performance conditions are satisfied. In addition to photopolymerizable functionality, the monomers incorporated into the photopolymerizable precursor may include other functionality or multiple functionalities of the same and/or different type.

In one embodiment of this invention, an isocyanate terminated (meth)acrylated polyurethane prepolymer is first prepared and dispersed into water containing a base. The (meth)acrylated polyurethane prepolymer dispersion is then mixed with a functionalized waterborne polymer component and chain extended. The functionalized waterborne polymer component may contain functional groups which are reactive with the isocyanate groups of the (meth)acrylated polyurethane prepolymer or the functional groups of the chain extender. The functionalized waterborne polymer component may comprise latex polymers, water-reducible alkyds, alkyd emulsions, acrylic polymers, alkyd-acrylic hybrid polymer dispersions, polyester emulsions, fluoropolymer emulsions, polyurethane-acrylic dispersions, silicone emulsions, epoxy dispersions, epoxy-acrylic dispersions, water dispersible or emulsifiable polyisocyanates, polyethylene emulsions, polypropylene emulsions, polyurethane dispersions, polyamide dispersions and mixtures thereof. The functional group can be any functionality that is stable during the synthesis of the waterborne component or polyurethane component. The functional group of the functionalized waterborne polymer may include amino, hydroxy, mercapton, epoxy, and/or carbonyl (e.g., diacetone acrylamide (DAAM), acetoacetoxyethyl methacrylate (AAEM), etc.) groups. The (meth)acrylated polyurethane prepolymer may contain acetoacetoxy, epoxy, carbonyl, and/or maleic/fumaric functional groups. One skilled in the art will appreciate that functional groups that are sensitive to water would be treated accordingly without straying from the scope of the present disclosure.

In addition to the coreaction of a (meth)acrylated polyurethane component and the functionalized waterborne polymer component and/or the coreaction of either or both the (meth)acrylated polyurethane component and the functionalized waterborne component with the chain extender, depending on the functionalities present on each component, the residual components can further crosslink (either individually or together or with added crosslinkers) after application of the coating composition to the substrate.

Alternatively, in another embodiment, the isocyanate terminated polyurethane prepolymer is first prepared and dispersed in water, and then the (meth)acrylated functionalized waterborne polymer is immediately added to the polyurethane dispersion and subsequently chain extended.

In yet another embodiment, a (meth)acrylated latex is prepared and dispersed into a polyurethane prepolymer and subsequently chain extended. The (meth)acrylated latex may contain functional groups such as amino, hydroxy, epoxy, mercapto, carbonyl (e.g. diacetone acrylamide (DAAM), acetoacetoxyethyl methacrylate (AAEM)).

In yet another embodiment of this invention, the composition of the present invention may contain two or more functionalized waterborne components, such as, for example, a latex and a silicone emulsion. Other waterborne polymer components may include, for example, a combination of a latex and a water-reducible alkyd, or an epoxy dispersion and a silicone emulsion.

### (meth)acrylated Polyurethane Component

A (meth)acrylated polyurethane prepolymer composition of this invention is generally produced by first reacting an isocyanate reactive moiety-containing composition with an excess of isocyanate-functional material. The isocyanate-functional material can be a diisocyanate-functional material selected from the group of aromatic, cycloaliphatic or aliphatic diisocyanates. Examples of suitable diisocyanates include 1,6-hexamethylene diisocyanate, 2,4-toluene diisocyanate, 2,6-toluene diisocyanate, 1,4-phenylene diisocyanate, 4,4′-diphenylmethane diisocyanate, 2,4′-diphenylmethanediisocyanate, isophorone diisocyanate, cyclohexane-1,4-diisocyanate, 4,4′-dicyclohexylmethane diisocyanate, p-xylylene diisocyanate, meta-1,1,3,3-tetramethylxylylene diisocyanate and mixtures thereof Small amounts of trifunctional isocyanates such as, for example, a trimer of hexamethylene diisocyanate in the form of isocyanurate or biuret and the trimer of isophorone diisocyanate may be used; however, an appreciable percentage of such isocyanate ingredients is not acceptable due to the crosslinking effect and increased viscosity of both the intermediate and the final product. When a mixture of two or more isocyanates is used, the ratio of NCO equivalents contributed by the individual isocyanates is not critical. In one embodiment, the isocyanate-functional material is a diisocyanate selected from the group consisting of 4,4′-dicyclohexylmethane diisocyanate, meta-1,1,3,3-tetramethylxylylene diisocyanate, isophorone diisocyanate and mixtures thereof

The isocyanate-reactive moiety-containing composition that is reactive with the isocyanate is preferably difunctional with respect to isocyanate groups; that is, they have two isocyanate-reactive moieties. The isocyanate-reactive moiety-containing composition can be a polyol, such as a diol selected from the group consisting of polyester diol, polyether diol, polyacetal diol, polyamide diol, polyester polyamide diol, poly(alkylene ether) diol, polythioether diol and polycarbonate diol.

Suitable polyether diols are, for example, the condensation products of ethylene oxide, propylene oxide, butylene oxide, or tetrahydrofuran, and their copolymerization, graft or block polymerization products, such as, mixed ethylene oxide, propylene oxide condensates. Suitable polyethers are prepared by the condensation of the mentioned alkylene oxides with polyhydric alcohols, such as, ethylene glycol, 1,2-propylene glycol and 1,4-butanediol.

Suitable polyester diols, polyester amide diols and polyamide diols can be saturated and are obtained, for example, from the reaction of saturated or unsaturated polycarboxylic acid with saturated or unsaturated polyhydric alcohol. Suitable carboxylic acids for preparing these compounds include, for example, adipic acid, succinic acid, phthalic acid, terephthalic acid, and maleic acid. Suitable polyhydric alcohols for preparing the polyester diols include, for example, ethylene glycol, 1,2-propylene glycol, 1,4-butanediol, neopentyl glycol, hexanediol, and trimethylolpropane. A suitable amino alcohol for preparing polyester amide diols is, for example, ethanolamine. Suitable diamines for preparing polyesteramide diols and polyamide diols are, for example, ethylene diamine and hexamethylene diamine.

Suitable polyacetals can be prepared, for example, from 1,4-butanediol or hexanediol and formaldehyde. Suitable polythioether diols can be prepared, for example, by the condensation of thiodiglycol with ethylene oxide, propylene oxide, butylene oxide or tetrahydrofuran.

Additional useful diols include Bisphenol A, polybutadiene based diols, polysiloxane based diols, fluorinated diols and mixtures thereof. In addition to the polyols disclosed above, compounds such as diamines, aminoalcohols and mercaptans, are also useful.

Useful difunctional isocyanate-reactive moiety-containing starting materials are a combination of 1) the polyester polyols formed from the reaction of saturated and unsaturated dihydric alcohols such as ethylene glycol, propylene glycol, neopentyl glycol, 1,4-butanediol, 1,4-butenediol, 1,6-hexanediol, furan dimethanol, and cyclohexane dimethanol with saturated and unsaturated polycarboxylic acids such as maleic acid, fumaric acid, itaconic acid, succinic acid, glutaric acid, adipic acid, isophthalic acid, terephthalic acid, phthalic anhydride, dimethyl terephthalate, dimer acids and the like; and 2) a diol containing hydrophilic groups. An example of a useful polyester polyol is Piothane 70-1000 HAI or Piothane 70-500, both commercially available from Panolam Industries International, Inc., Auburn, Me. Also useful for this invention is a diol containing hydrophilic groups, such as dimethylolpropionic acid, available from Perstorp Corporation, Toledo, Ohio. When used, these two diols are preferably present in percentages such that the Piothane material contributes between about 30% to about 70% of the isocyanate-reactive hydroxyl functionality of the total materials. As the examples below demonstrate, an embodiment can comprise Piothane 70-1000, trimethylolpropane and dimethylolpropionic acid.

Although in one embodiment, difunctional isocyanate-reactive containing compounds can be used, small amounts of tri- and higher functional compounds may be used. Examples of such higher functional compounds include trimethylol propane, pentaerythritol, polyester triols and polyether triols. Large amounts of such higher functional compounds will create a highly branched, crosslinked prepolymer that is difficult to disperse into water.

Preparation of a (meth)acrylated polyurethane prepolymer is typically carried out by charging the isocyanate-reactive moiety-containing composition with the catalyst to a reaction vessel, heating the contents to a temperature of between about 85° C. and about 100° C., and adding, via continuous or stepwise addition over a period of time, preferably between about 0.5 hour to about 1.5 hours, the isocyanate-functional materials. Optionally present can be a solvent such as n-methyl-2-pyrrolidone, dimethyl formamide, acetone, methyl ethyl ketone, toluene, and mixtures thereof in an amount ranging up to about 20% by weight based upon the total weight of the materials present in the reaction vessel. After complete addition of the isocyanate materials, the reaction vessel temperature is maintained at between about 85° C. and 100° C. for approximately 3 to 4.5 hours. The residual isocyanate percentage can be measured by any means well-known in the art. At this point, a polyurethane prepolymer is now formed and any excess solvent can be distilled. Some excess isocyanate functionality is then reacted with an isocyanate-reactive photopolymerizable (meth)acrylate material (e.g., hydroxyalkyl methacrylate) and optionally chain extended when dispersed into water and the functionalized waterborne component.

During the preparation of an isocyanate-functional (meth)acrylated polyurethane prepolymer, a preferred ratio of total isocyanate-reactive moiety functionality to isocyanate should be such that there is an excess of isocyanate functionality over isocyanate-reactive moiety-functionality. The ratio of molar equivalents of isocyanate to total isocyanate-reactive moiety can be between about 1.01:1 to about 2.0:1; and in another embodiment, between about 1.01:1 to about 1.7:1. Examples of especially suitable compounds containing an isocyanate-reactive functional group and a group that is photopolymerizable (e.g., one which can be activated with actinic radiation) are monomers which carry at least one hydroxyl or amino group per molecule, such as hydroxyalkyl esters of acrylic acid, methacrylic acid or another alpha,beta-olefinically unsaturated carboxylic acid which derive from an alkylene glycol which is esterified with the acid or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2- hydroxypropyl, 3-hydroxypropyl, 3-hydroxybutyl, 4-hydroxybutyl acrylate, methacrylate, ethacrylate, crotonate, maleate, fumarate or itaconate; or methylpropanediol monoacrylate, monomethacrylate, monoethacrylate, monocrotonate, monomaleate, monofumarate or monoitaconate; or hydroxycycloalkyl esters such as cyclohexanedimethanol, 1,4-bis(hydroxymethyl)cyclohexane, 1,4-dihydrocyclohexane or octahydro-4,7- methano-1H-indene-dimethanol monoacrylate, monomethacrylate, monoethacrylate, monocrotonate, monomaleate, monofumarate or monoitaconate; or the reaction products of all these hydroxyalkyl or hydroxycycloalkyl esters with cyclic esters, such as epsilon-caprolactone, for example; olefinically unsaturated alcohols such as allyl alcohol; polyols such as trimethylolpropane monoallyl or diallyl ether or pentaerythritol monoallyl, trimethylolpropane diacrylate, reaction products of acrylic acid and/or methacrylic acid with the glycidyl ester of an alpha-branched monocarboxylic acid having 5 to 18 carbon atoms per molecule, especially of a Versatic™ acid (available from Hexion Specialty Chemicals, Columbus, Ohio), or instead of the reaction product an equivalent amount of acrylic and/or methacrylic acid which is then reacted, during or after the polymerization reaction, with the glycidyl ester of an alpha-branched monocarboxylic acid having 5 to 18 carbon atoms per molecule, in particular a Versatic™ acid; aminoethyl acrylate, aminoethyl methacrylate, allylamine or N-methyliminoethyl acrylate; and/or acryloyloxysilane-containing vinyl monomers, preparable by reacting hydroxy-functional silanes with epichlorohydrin and then reacting the reaction product with (meth)acrylic acid and/or hydroxyalkyl and/or hydroxycycloalkyl esters of (meth)acrylic acid and/or further hydroxyl-containing monomers, and mixtures thereof, where the isocyanate reactive moiety is added to the composition in an amount of 5 mole percent to 20 mole percent of the excess isocyanate functionality. Suitable compounds are hydroxyethyl acrylate and hydroxyethyl methacrylate. A small amount of free radical inhibitor can be mixed with these isocyanate-ractive monomers to preserve the (meth)acrylate functionality during urethane dispersion synthesis. Suitable inhibitors are sold by Ciba Specialty Chemicals under the Irganox™ trade name, and other inhibitors such as butylated hydroxyl toluene (BHT) from Chemtura Corporation, Morgantown, W.Va. Optionally, and preferably present during the reaction is up to about 0.06%, preferably between about 0.01% and about 0.04% (by weight based upon total solids of isocyanate-reactive moiety-containing compositions and diisocyanate) of a catalyst such as di-butyl tin dilaurate, tin octoate and the like.

In one embodiment, the (meth)acrylated polyurethane component contains at least one functional group that enables the (meth)acrylated polyurethane component to further crosslink once the composition has been applied to the substrate.

To ensure that the (meth)acrylated polyurethane prepolymer is dispersible in water and/or the functional waterborne component, pendant ionizable groups are incorporated into the prepolymer and then subsequently ionized. Useful ionizable groups include pendant groups such as carboxylate, sulfonate, sulfate, phosphonate and/or phosphate groups located along the polymer backbone. For example, carboxylate groups which are derived by preparing the (meth)acrylated polyurethane prepolymer from an active hydrogen containing composition having a carboxyl group are useful. For example, diols, diamines and difunctional thiols containing a carboxyl group are useful. An example of a carboxy-functional isocyanate-reactive compound is dimethylolpropionic acid. The (meth)acrylated polyurethane prepolymer must contain a sufficient amount of the carboxyl groups which are ionized by neutralization to render the (meth)acrylated polyurethane prepolymer dispersible. Between about 1% by weight and about 10% by weight of the (meth)acrylated polyurethane prepolymer is contributed by isocyanate-reactive moiety-containing compounds having ionizable groups.

The ionizable groups of the (meth)acrylated polyurethane prepolymer may be ionized by combining the prepolymer with water containing a tertiary amine, or by adding the tertiary amine to the prepolymer and then dispersing in water. Tertiary amines that may be used include triethylamine, trimethylamine, triisopropyl amine, tributyl amine, N,N-dimethyl-cyclohexyl amine, N,N-dimethylstearyl amine, N,N-dimethyl aniline, N-methylmorpholine, N-ethylmorpholine, N-methylpyrrolidine, N,N-dimethyl-ethanol amine, N,N-diethyl-ethanol amine, triethanol amine, N-methyldiethanol amine, N,N-dimethylaminopropanol, 5-N,N-diethylamino-2-pentanone and mixtures thereof, and dispersed. The amount of tertiary amine added should be sufficient to neutralize at least about 90% of the ionic groups present in solution. Preferably, the tertiary amine is added in an amount sufficient to neutralize 100% of the ionic groups. Other weak bases may be used to neutralize the ionic groups, but tertiary amines are preferred because they do not react with the free isocyanate groups of the prepolymer.

The prepolymer is dispersed in water containing a tertiary amine such as, for example, triethylamine, which neutralizes the ionic groups of the prepolymer. Once the (meth)acrylated polyurethane prepolymer is dispersed in water, the dispersion is ready for incorporation of the waterborne polymer component.

Overall, the weight ratio of (meth)acrylated polyurethane prepolymer component to functionalized waterborne polymer component is generally in the range of about 1:99 to about 99:1, preferably from about 1:5 to about 1:1.

In order to chain extend the (meth)acrylated polyurethane prepolymer, a functional compound capable of chain extending the (meth)acrylated polyurethane prepolymer such as a polyol, an amino alcohol, a primary or secondary aliphatic, alicyclic, aromatic or heterocyclic amine or diamine, ammonia, or an amine functional silicone may be used. Water-soluble chain extenders are preferred. Examples of suitable chain extenders include ethylene diamine, propylene diamine, butylene diamine, hexamethylene diamine, cyclohexylene diamine, piperazine, isophorone diamine, phenylene diamine, tolylene diamine, xylylene diamine, hydrazine, dimethylhydrazine, adipic dihydrazide, diaminoalkoxy silanes, mixtures thereof, equivalents thereof and the like in an amount sufficient to react with up to at least 90% of the theoretical amount of residual NCO functionality is generally added to the composition for chain extension of the (meth)acrylated polyurethane. Chain extenders having a functionality greater than two such as, for example, diethylenetriamine, can also be included but should be limited to a small amount to avoid creating a composition that is highly crosslinked. However, it can be appreciated by one skilled in the art that polyamine may not be necessary for chain extension since the isocyanate-functional prepolymer is typically branched to some extent, and may hydrolyze to amines, thereafter acting as a polyamine chain extender.

As discussed above, the dispersing media for the (meth)acrylated polyurethane prepolymer can be water to which the functionalized waterborne polymer component is subsequently added. Alternatively, the dispersing media can be a combination of a functionalized waterborne polymer component and additional base.

### Waterborne Polymer Component

Conventional latex polymers may be used as the waterborne polymer component, as well as functionalized waterborne polymers that contain functional groups such as amino, hydroxyl, mercapto, epoxy or carbonyl (e.g., diacetone acrylamide (DAAM)), acetoacetoxyethyl methacrylate (AAEM)). The waterborne polymer component may comprise latex polymers, water-reducible alkyds, alkyd emulsions, acrylic polymers, alkyd-acrylic hybrid polymer dispersions, polyester emulsions, fluoropolymer emulsions, polyurethane-acrylic dispersions, silicone emulsions, epoxy dispersions, epoxy-acrylic dispersions, water dispersible or emulsifiable polyisocyanates, polyethylene emulsions, polypropylene emulsions, polyurethane dispersions, polyamide dispersions and mixtures thereof.

Conventional latex polymers are prepared by polymerizing at least one ethylenically unsaturated monomer in water using surfactants and water soluble initiators. Typical ethylenically unsaturated monomers include vinyl monomers, acrylic monomers, allylic monomers, acrylamide monomers, and mono- and dicarboxylic unsaturated acids. Vinyl esters include vinyl acetate, vinyl propionate, vinyl butyrates, vinyl isopropyl acetates, vinyl neodecanoate and similar vinyl esters; vinyl halides include vinyl chloride, vinyl fluoride, and vinylidene chloride; vinyl aromatic hydrocarbons include styrene, α-methyl styrenes, and similar lower alkyl styrenes. Acrylic monomers include monomers such as lower alkyl esters of acrylic or methacrylic acid having an alkyl ester portion containing between 1 to 12 carbon atoms as well as aromatic derivatives of acrylic and methacrylic acid. Useful acrylic monomers include, for example, acrylic and methacrylic acid, methyl acrylate, and methacrylate, ethyl(meth)acrylate, butyl(meth)acrylate, propyl(meth)acrylate, 2-ethyl hexyl(meth)acrylate, cyclohexyl(meth)acrylate, decyl(meth)acrylate, isodecyl(meth)acrylate, and benzyl(meth)acrylate. Preparation of latex compositions is well-known in the paint and coatings art. Any of the well-known free-radical emulsion polymerization techniques used to formulate latex polymers can be used in the present invention.

Epoxy-functional latexes can be produced from monomers which include glycidyl(meth)acrylate, n-glycidyl acrylamide and allyl glycidyl ether. Acetoacetoxy functional latexes include those that contain acetoacetoxyethyl methacrylate, acetoacetoxy ethyl acrylate, acetoacetoxypropyl methacrylate, allyl acetoacetate, acetoacetoxybutyl methacrylate, 2,3-di(acetoacetoxy) propyl methacrylate and n-acetoacetyl acrylamide.

Hydroxy-functional latexes can be produced from polymerizable monomers such as allyl alcohol and hydroxy alkyl acrylates and methacrylates including, for example, hydroxylethyl(meth)acrylate, hydroxypropyl(meth)acrylate, hydroxybutyl (meth)acrylate and mixtures thereof.

One embodiment of this invention is a (meth)acrylated latex emulsion commercially available under the trade designation “ROSHIELD 3120” from Rohm and Haas Company, Philadelphia, Pa. This emulsion is available at a solids content of about 40.5% by weight. In another embodiment, the (meth)acrylated latex may contain additional functionality that may react with a chain extender or crosslinker, or allow an additional cure mechanism upon film formation if an optional crosslinker is added to the formulated coating. For example, a methacrylated latex containing DAAM can be prepared by first making an acid-functional DAAM latex followed by reaction with glycidyl methacrylate. The (meth)acrylated DAAM latex can then be used to make a photopolymerizable interpenetrating polymer network as taught herein that can be used to make a dual cure coating with added photoinitiator and adipic dihydrazide crosslinker.

Photoinitiators are chemical compounds that decompose into free radicals when exposed to light. These free radicals are capable of initiating the polymerization of the polymerizable constituents within a coating. Suitable photoinitiators include for example: aromatic carbonyl compounds such as benzyl, benzyl dimethyl ketal, acetophenone, substituted acetophenones, thioxanthone chlorothioxanthone and preferably benzophenone. Most radiation curing is performed using near UV light (300-400 nm range), but initiators expanding into the visible up to the IR range or on the blue side to deep UV are also available today. The light absorption in the near UV/ visible of monoacylphosphine oxide photoinitiators such as Lucirin TPO (BASF/Ciba) results in efficient formation of free radicals, all of which can efficiently initiate polymerization. Since the photoreaction is accompanied by the destruction of the chromophore responsible for absorption, efficient photobleaching of the long wave absorption chromophore is observed. The photoinitiator, therefore, does not impart yellowing in the cured coating. Acylphosphine oxide photoinitiators, for example, allow a higher conversion of (meth)acrylic unsaturation in white coatings containing rutile titanium dioxide pigments. Although rutile titanium dioxide exhibits excellent hiding power and absorbs light over the whole UV region up to 380 nm, transparency above 420 nm allows acylphosphine oxide photoinitiators to absorb energy and initiate free radicals to cure coatings, especially in sun light. Optionally, use may be made of compounds such as aromatic azo compounds and compounds such as benzoin and ethers thereof, such as the methyl ether, the ethyl ether, the propyl ether and the t-butyl ether. Mixtures of photoinitiators may also be used.

The weight ratio of the (meth)acrylated latex component to the polyurethane component is generally in the range of about 1:99 to about 99:1, preferably from about 5:1 to about 1:1. Depending on the light source, intensity and pigment volume concentration of the coating, the amount of photoinitiator to cure a coating will vary. Because of the high cost of the photoinitiators, the amount of photoinitiator has to be limited to less than 5% to give a cost effective cure. Clear coatings without pigment cure most efficiently. Increasing photoinitiator concentrations are necessary as the pigment volume concentration increases. The photoinitiator can be present in an amount of approximately 0.05 to 10% by weight, based on the weight of the photopolymerizable interpenetrating network. Some free radical polymerizations are inhibited by oxygen and may require provision of an inert atmosphere.

Photocurable interpenetrating polymer network compositions may be formulated to also include photopolymerizable reactive diluents. Representative examples of photopolymerizable monomers or multi-functional (meth)acrylates suitable for use as reactive diluents include 1,2,4-butanetriol tri(meth)acrylate, 1,3-propanediol di(meth)acrylate, 1,4-cyclohexanediol di(meth)acrylate, 2-(2-ethoxyethoxy)ethyl(meth)acrylate, 2-ethylhexyl(meth)acrylate, acrylated oligomers such as those of U.S. Pat. No. 4,642,126 diallyl phthalate, diethyleneglycol diacrylate, ethyleneglycol di(meth)acrylate, glycerol di(meth)acrylate, glycerol tri(meth)acrylate, isobornyl acrylate, tetrahydrofurfuryl(meth)acrylate, combinations of these, and the like. Such reactive diluents can typically be added in amounts in the range of 0.5 to 50% by weight based on resin solids.

### Coating Formulas

Once dispersed into the dispersing media, the composition can be modified with other standard ingredients commonly used to formulate paints and coatings. For example, the dispersions of this invention can be combined with other ingredients such as pigments, extenders, dispersants, surfactants, colorants, paraffins, waxes, UV light stabilizers, rheology modifiers, mildewcides, biocides, fungicides, and other conventional additives. Colorants and pigment dispersions, when used, are typically added in amounts up to about 15% by volume of the total composition.

The compositions of the present invention can be crosslinked by ultraviolet or visible light.

### Examples

The following examples demonstrate methods of preparation of the compositions of this invention. They also demonstrate the preparation of representative polyurethane components and representative waterborne polymer components. The examples are intended to be representative of the formulations which can be made and are not intended to limit the scope of the invention.

### Example 1

### Preparation of Acetoacetoxy Latex

To a 5-liter flask equipped with a stirrer, thermocouple, monomer inlet, initiator inlet and nitrogen inlet are charged 1000 g deionized water, 1.5 g sodium carbonate and 7.8 g Rhodapon UB (Rhodia) and heated to 80 C. To the charge at 80 C, 35 g of pre-emulsion #1 and 9 g of initiator mix #1 are added and held for 20-minutes. Pre-emulsion #1 consists of 130 g deionized water, 23.4 g Rhodapon SB 8208/S, 449.5 g methyl methacrylate, 3.5 g hexanediol diacrylate, 6.2 g methacrylic acid, 165.4 g ethylhexyl acrylate and 0.8 g dodecyl mercaptan. Initiator mix #1 consists of 1.7 g ammonium persulfate and 90 g deionized water.

The remainder of pre-emulsion #1 and initiator mix #1 are added simultaneously over 1.5-hours.

After a 15-minute hold, pre-emulsion #2 and initiator mix #2 are added over 4-hours. Pre-emulsion #2 consists of 340 g deionized water, 46.8 g Rhodapon UB, 220 g ethylhexyl acrylate, 346.5 g methyl methacrylate, 14 g methacrylic acid, 327.8 g Exxar Neo-12 (12-carbon vinyl ester formerly available from EXXON), 28 g 2-(methacryloxy)ethyl acetoacetate (Eastman), and 1.2 g dodecyl mercaptan. Initiator mix #2 consists of 2.6 g ammonium persulfate and 90 g deionized water.

After holding at 80 C for 15-minutes, the polymerization is cooled to 70 C and a chase consisting of separate feeds of 0.5 g sodium metabisulfite dissolved in 82.5 g deionized water and 1.3 g of 70% tertiary-butyl hydroperoxide in 82.5 g deionized water are added simultaneously over 30-minutes. After cooling to 30 C, a 28% ammonium hydroxide solution is added to adjust the pH to 8.45, NVM 43.4%, LVT Brookfield viscosity 30 rpm #3 spindle at 25 C is 100 cps, particle size 101 nanometers, minimum film formation temperature 23.6 C.

### Example 2

### Preparation of Methacrylated Diacetone Acrylamide Latex

To a 5-liter flask equipped with a stirrer, thermocouple, monomer inlet, initiator inlet and nitrogen inlet are charged 800 g deionized water and 20 g Rhodapon EST-30 (Rhodia) and heated to 80 C. To the charge at 80 C, 241 g of a pre-emulsion and 8.46 g of initiator solution are added and held for 20-minutes. The pre-emulsion consists of 780 g deionized water, 58 g Rhodapon EST-30, 532 g methyl methacrylate, 750 g butyl acrylate, 187.6 g methacrylic acid, 62 g styrene, and 46 g diacetone acrylamide. Initiator solution consists of 80 g deionized water and 4.6 g ammonium persulfate. The remainder of the pre-emulsion is added over 3-hours while the initiator solution is fed over 200-minutes. After holding 1-hour at 80 C, the polymerization is cooled to 50 C and a chase consisting of two simultaneous feeds consisting of 1.3 g 70% tertiary-butyl hydroperoxide with 20 g deionized water and 1 g sodium metabisulfite with 20 g deionized water is fed over 30-minutes. The latex is cooled to room temperature: pH 2.4, NVM 46.3%, LVT Brookfield viscosity 30 rpm #3 spindle at 25 C is 394 cps.

The latex from above (2100 g) is charged to a 5-liter flask equipped with a stirrer, thermocouple, monomer inlet and nitrogen inlet. A mixture of 1000 g deionized water, 6 g triethylamine, and 17 g Igepal CA 897 (Rhodia) is added to the latex of Example 1 and heated to 80 C. A mixture of 180 g glycidyl methacrylate and 1 g Naugard BHT (2,6-di-tertiary-butyl-p-cresol, Chemtura) is fed over 2-hours and 45-minutes. After 2-hours at 80 C, a solution of 8 g triethylamine in 45 g deionized water is added over 90-minutes. After holding at 80 C for 30-minutes, the dispersion is cooled to room temperature and the pH adjusted to 7.8 with about 20 g 28% ammonium hydroxide solution and then filtered through a 250-micron nylon filter bag to give a methacrylated latex: NVM 35.6%, LVT Brookfield viscosity 30 rpm #3 spindle at 25 C is 864 cps.

### Example 3

### Preparation of Interpenetrating Polymer Network Methacrylated Urethane Pre Polymer+Acetoacetoxy Latex

To a 1-liter resin kettle equipped with a stirrer, addition funnel, thermocouple and nitrogen inlet, 237 g of Piothane 70-1000 HAI polyester polyol, 23.8 g of dimethyolpropionic acid, 2.4 g trimethyolpropane, 90.7 g N-methyl pyrrolidone and 0.02 g dibutyltin dilaurate are charged. The charge is heated to 85 C with stirring and 213 g Desomodur W diisocyanate is added over 45-minutes while maintaining the temperature at 85 C. After addition is complete, the reaction continued to heat at 85 C for 3-hours to a percent excess isocyanate of about 5.35% and then 4.7 g of hydroxyethyl methacrylate is added and held an additional 30-minutes at 85 C. The reaction is cooled to 80 C and 17.97 g of triethylamine is added and then the urethane prepolymer is immediately poured into a stirred 1-gallon vessel containing 600 g of deionized water and 731 g of the 43.4% solids latex from Example 1. After the prepolymer is completely dispersed, a solution of 19.98 g of ethylenediamine in 20 g of water is added to chain extend the prepolymer to form the interpenetrating polymer dispersion: pH 8.90, NVM 41.9%, LVT Brookfield viscosity 30 rpm #3 spindle at 25 C is 260 cps (centipoises).

### Example 4

### Preparation of Interpenetrating Polymer Network Urethane Pre-Polymer+Methacrylated Diacetone Acrylamide Latex

To a 1-liter resin kettle equipped with a stirrer, addition funnel, thermocouple and nitrogen inlet, 110 g of Piothane 70-1000 HAI polyester polyol, 9.5 g of dimethyolpropionic acid, 1.3 g trimethyolpropane, 41.1 g N-methyl pyrrolidone and 0.02 g dibutyltin dilaurate are charged. The charge is heated to 85 C with stirring and 95 g Desomodur W diisocyanate is added over 45-minutes while maintaining the temperature at 85 C. After addition is complete, the reaction continued to heat at 85 C for 3-hours to a percent excess isocyanate of about 5.22%. The reaction is cooled to 80 C and 12.7 g of triethylamine is added and then the urethane prepolymer is immediately poured into a stirred 1-gallon vessel containing 130 g of deionized water and 1124 g of the 35.6% solids latex of Example 2. After the prepolymer is completely dispersed, a 55% solution of 6.4 g of hydrazine hydrate is added to chain extend the prepolymer to form the interpenetrating polymer dispersion: pH 8.09, NVM 33.24%, LVT Brookfield viscosity 30rpm #3 spindle at 25 C is 100cps (centipoises).

### Example 5

### Preparation of a Coating Composition 17 PVC White Paint

A 17 pigment volume concentration paint is made using the following ingredients:

| | |
|---|---|
| Deionized Water | 52.7 g |
| BYK 190 | 6.3 g |
| DuPont R706 TiO₂ | 210.8 g |
| IPN of Example 3 | 708.7 g |
| Dipropylene Glycol mono Butyl Ether | 33.2 g |
| Dipropylene Glycol mono Methyl Ether | 8.3 g |

The above paint is applied to a Bonderite 1000 panel at about 1.5 dry film thickness and baked to 60 C for 30-minutes. Another paint is coated in the same way, except 2% by weight (based on the IPN resin weight) of Lucirin TPO (available from Ciba) photoinitiator is dissolved in the cosolvents listed above, and exposed to the sun. Exposure to the sun allowed the paint with photoinitiator to exhibit the same coatings properties as the baked panel: passed greater than 200 methyl ethyl ketone (MEK) double rubs, H pencil hardness and 160 inch-pound direct impact.

### Example 6

### Preparation of a Coating Composition 17 PVC White Paints

Three 17 pigment volume concentration paints are made using the following ingredients, with or without Lucirin TPO photoinitiator:
Paint A 30-day room temperature cured with Adipic Dihydrazide (ADH)
Paint B 30-day outside exposure cured with ADH
Paint C 30-day outside exposure cured with lowest level ADH and Lucirin TPO

| Ingredient | Paint A | Paint B | Paint C |
|---|---|---|---|
| Deionized Water | 43.8 | 44.5 | 39.6 |
| ADH | 3.3 | 3.2 | 2.3 |
| BYK 190 dispersant | 5.2 | 5.3 | 4.7 |
| DuPont R706 TiO₂ | 175.1 | 178.2 | 173.3 |
| IPN from Example 4 | 695.7 | 683.8 | 683.8 |
| Texanol (Eastman) | 19.8 | 19.2 | 18.2 |
| 10% sodium Nitrite solution | 3.7 | 3.7 | 3.6 |
| Texanol | 4.95 | 4.80 | 4.54 |
| Lucirin TPO | — | — | 4.6 |
| Chemical Solvent resistance | 15 | 15 | 20 |
| total rating* | | | |
| MEK double rubs | 60 | 60 | 90 |

*Chemical Solvent resistance total rating: is a total score from the 24-hour resistance to six different chemical spots.. The six chemicals are: Toluene, Ethanol, MEK, 10% Sulfuric Acid, 10% Sodium Hydroxide, Windex Formula 409 Cleaner. The film resistance to the spots are rated: 2 = partially dissolved, 3 = not dissolved but whitened, 4 = whitened but recovered, 5 = no change

The above paints are applied to Bonderite 1000 panels at about 1.5 dry film thickness and cured during the same 30-day period. Paint A (room ADH) exhibited MEK double rubs equivalent to Paint B (outside ADH), while Paint C (outside ADH+TPO) exhibited a 50% increase in MEK double rubs and much improved solvent resistance.

What is claimed is:

1. A resin composition comprising an interpenetrating polymer network comprising:
(a) 5 to 95 weight percent of a polyurethane prepolymer;
(b) 5 to 95 weight percent of a waterborne polymer component; and
(c) optionally, a chain extender or crosslinker;
wherein either the polyurethane prepolymer has at least one functional group that is photopolymerizable, or the waterborne polymer component has at least one functional group that is photopolymerizable; or wherein both the polyurethane prepolymer and waterborne polymer component have at least one functional group that is photopolymerizable.

2. The composition of claim 1, wherein the photopolymerizable group of the polyurethane prepolymer and/or waterborne polymer component can selected from the group consisting of (meth)acrylate, olefinic carbon-carbon double bonds, allyloxy, α-methyl styrene, (meth)acrylamide, or combinations thereof.

3. The composition of claim 1, wherein either the polyurethane prepolymer or the waterborne polymer component, or both, contain an additional functional group that can polymerize, chain extend or crosslink in the presence of a chain extender or a crosslinker.

4. The composition of claim 1, wherein the at least one functional group of the polyurethane prepolymer is a methacrylate.

5. The composition of claim 1, wherein the at least one functional group of the functionalized waterborne polymer component is a methacrylate.

6. The composition of claim 1, wherein the chain extender or crosslinker is a polyamine.

7. The composition of claim 1, wherein the additional functional group for the functionalized waterborne polymer component, other than photopolymerizable functional groups, are amino, hydroxyl, mercapto, carbonyl, acetoacetoxy or epoxy.

8. The composition of claim 3, wherein the additional functional group for the functionalized polyurethane prepolymer is selected from the group consisting of acetoacetoxy, epoxy, carbonyl, maleic and fumaric.

9. The composition of claim 1, further comprising a photoinitiator.

10. The composition of claim 1, wherein the waterborne polymer component further comprises a crosslinker.

11. The composition of claim 10, wherein the crosslinker is selected from the group consisting of adipic dihydrazide and polyamine.

12. The composition of claim 1, wherein the chain extender or crosslinker can be selected from the group consisting of ethylene diamine, propylene diamine, butylene diamine, hexamethylene diamine, cyclohexylene diamine, piperazine, isophorone diamine, phenylene diamine, tolylene diamine, xylylene diamine, hydrazine, dimethylhydrazine, adipic dihydrazide, diaminoalkoxy silanes, mixtures thereof.

13. The composition of claim 1, wherein the chain extender or crosslinker is present in an amount sufficient to react with up to at least 90% of the theoretical amount of residual isocyanate functionality of the (meth)acrylated polyurethane.

14. The composition of claim 9, wherein the photoinitiator is present in an amount of 0.05 percent by weight to 10 percent by weight, based on the weight of the photopolymerizable internpenetrating network.

15. The composition of claim 1, further comprising a reactive diluent in an amount in the range of 0.5 to 50% by weight based on resin solids.
